(19) United States
(12) Patent Application Publication
(10) Pub. No.: US 2024/0408792 A1
(43) Pub. Date: Dec. 12, 2024

(54) MACHINE-LEARNING METHOD, MACHINE-LEARNING DEVICE, MACHINE-LEARNING PROGRAM, COMMUNICATION METHOD, AND CONTROL DEVICE

(71) Applicant: KABUSHIKI KAISHA KOBE SEIKO SHO (KOBE STEEL, LTD.), Hyogo (JP)

(72) Inventors: Hiroyuki ITO, Takasago-shi, Hyogo (JP); Tomoya MINAMINO, Takasago-shi, Hyogo (JP); Hiroshi SHIRAKASHI, Takasago-shi, Hyogo (JP); Yoshikazu KISHI, Takasago-shi, Hyogo (JP); Tadataka MIZOKAMI, Takasago-shi, Hyogo (JP); Yasuhide MIYASHITA, Takasago-shi, Hyogo (JP)

(73) Assignee: KABUSHIKI KAISHA KOBE SEIKO SHO (KOBE STEEL, LTD.), Hyogo (JP)

(21) Appl. No.: 18/701,906

(22) PCT Filed: Sep. 30, 2022
(86) PCT No.: PCT/JP2022/036834

§ 371 Date: Apr. 16, 2024

(30) Foreign Application Priority Data
Oct. 22, 2021 (JP) 2021-173018

(51) Int. Cl. B28B 17/00; B22F 3/04; B28B 3/00; G06N 3/092

(52) U.S. Cl. CPC B28B 17/0081; B22F 3/04; B28B 3/003; G06N 3/092; B22F 2203/13

(57) ABSTRACT

A reward for a decision result of an isostatic pressurization processing condition is calculated based on a state variable including at least one physical quantity related to a workpiece and at least one isostatic pressurization processing condition, a function for deciding at least one isostatic pressurization processing condition from the state variable is updated based on the reward, and updating of the function is repeated to decide an isostatic pressurization processing condition that maximizes the reward. The isostatic pressurization processing condition is at least one of a first parameter related to the workpiece, a second parameter related to a pre-process of the isostatic pressurization processing, and a third parameter related to an operating condition of an isostatic pressurization device, and the at least one physical quantity is at least one of physical quantities related to densification and green compaction of the workpiece.

### TECHNICAL FIELD

The present invention relates to a technique for machine-learning of an isostatic pressurization condition of an isostatic pressurization device.

### BACKGROUND ART

Conventionally, for the purpose of compression-molding a workpiece made of powder such as ultra-hard ceramic by pressurizing, there has been known a pressurization device (CIP device: isostatic pressurization device) that performs pressurization processing on a workpiece using a CIP method (cold isostatic pressing method) or a WIP method (warm isostatic pressing method) (e.g., Patent Literature 1). In such a pressurization device, a workpiece is housed in a cylindrical pressure vessel, and a pressure medium such as water is sealed in the pressure vessel to perform pressurization processing. In order to obtain a high-quality CIP-processed article in such pressurization processing, it is required to appropriately decide CIP processing conditions such as pressurization conditions.

### CITATION LIST

### Patent Literature

Patent Literature 1: JP H8-252695 A

However, since CIP processing conditions are conventionally decided on the basis of accumulated experimental data, it is difficult to easily decide an appropriate CIP processing condition for a workpiece.

### SUMMARY OF INVENTION

An object of the present invention is to provide a machine-learning method and the like that enable an appropriate CIP processing condition for a workpiece to be efficiently derived.

A machine-learning method according to one aspect of the present invention is a machine-learning method in which a machine-learning device decides an isostatic pressurization processing condition of an isostatic pressurization system that performs isostatic pressurization processing on a workpiece using a pressure medium. The isostatic pressurization system includes: an isostatic pressurization device that includes a pressure vessel that stores the workpiece, and is configured by a cold isostatic pressurization device or a warm isostatic pressurization device: a compressor configured to supply the pressure medium to the pressure vessel: a pressure adjustment mechanism capable of adjusting a pressure in the pressure vessel; and a control device that controls the isostatic pressurization device. The machine-learning method includes acquiring a state variable including at least one physical quantity related to the workpiece and at least one isostatic pressurization processing condition: calculating a reward for a decision result of the at least one isostatic pressurization processing condition based on the state variable; updating, based on the reward, a function for deciding the at least one isostatic pressurization processing condition from the state variable while changing the at least one isostatic pressurization processing condition; and deciding an isostatic pressurization processing condition that maximizes the reward by repeating updating of the function. The at least one isostatic pressurization processing condition is at least one of a first parameter related to the workpiece, a second parameter related to a pre-process of the isostatic pressurization processing, and a third parameter related to an operating condition of the isostatic pressurization device, and the at least one physical quantity is at least one of physical quantities related to densification and green compaction of the workpiece.

Note that in the present invention, each processing included in the machine-learning method may be implemented in a machine-learning device, or may be implemented and distributed as a machine-learning program. The machine-learning device may be configured by a server or may be configured by an isostatic pressurization device.

A communication method according to another aspect of the present invention is a communication method of a control device of an isostatic pressurization device at a time of machine-learning an isostatic pressurization processing condition of the isostatic pressurization system, the isostatic pressurization system performing isostatic pressurization processing on a workpiece using a pressure medium. The isostatic pressurization system includes: an isostatic pressurization device that includes a pressure vessel that stores the workpiece, and is configured by a cold isostatic pressurization device or a warm isostatic pressurization device; a compressor configured to supply the pressure medium to the pressure vessel; a pressure adjustment mechanism capable of adjusting a pressure in the pressure vessel; and the control device. The control device observes a state variable including at least one physical quantity related to the workpiece and at least one isostatic pressurization processing condition. The control device transmits the state variable to a server via a network and receives at least one machine-learned isostatic pressurization processing condition from the server. The at least one isostatic pressurization processing condition is generated by the server calculating a reward for a decision result of the at least one isostatic pressurization processing condition based on the state variable; updating, based on the reward, a function for deciding the at least one isostatic pressurization processing condition from the state variable while changing the at least one isostatic pressurization processing condition; and deciding an isostatic pressurization processing condition that maximizes the reward by repeating updating of the function. The at least one isostatic pressurization processing condition is at least one of a first parameter related to the workpiece, a second parameter related to a pre-process of the isostatic pressurization processing, and a third parameter related to an operating condition of the isostatic pressurization device, and the at least one physical quantity is at least one of physical quantities related to densification and green compaction of the workpiece.

A control device according to a further aspect of the present invention is a control device of an isostatic pressurization system that performs isostatic pressurization processing on a workpiece using a pressure medium. The isostatic pressurization system includes: an isostatic pressurization device that includes a pressure vessel that stores the workpiece, and is configured by a cold isostatic pressurization device or a warm isostatic pressurization device; a compressor configured to supply the pressure medium to the pressure vessel; a pressure adjustment mechanism capable of adjusting a pressure in the pressure vessel; a state observation part that observes a state variable including at least one physical quantity related to the workpiece and at least one isostatic pressurization processing condition; and a communication part that transmits the state variable to a server via a network and receives at least one machine-learned isostatic pressurization processing condition from the server. The at least one isostatic pressurization processing condition is generated by the server calculating a reward for a decision result of the at least one isostatic pressurization processing condition based on the state variable; updating, based on the reward, a function for deciding the at least one isostatic pressurization processing condition from the state variable while changing the at least one isostatic pressurization processing condition; and deciding an isostatic pressurization processing condition that maximizes the reward by repeating updating of the function. The at least one isostatic pressurization processing condition is at least one of a first parameter related to the workpiece, a second parameter related to a pre-process of the isostatic pressurization processing, and a third parameter related to an operating condition of the isostatic pressurization device, and the at least one physical quantity is at least one of physical quantities related to densification and green compaction of the workpiece.

### BRIEF DESCRIPTION OF DRAWINGS

FIG. 1 is an overall configuration view of a CIP system to be a learning target in an embodiment of the present invention.

FIG. 2 is an overall configuration diagram of a machine-learning system that causes the CIP system according to the embodiment of the present invention to perform machine-learning.

FIG. 3 is a diagram illustrating an example of CIP processing conditions.

FIG. 4 is a graph showing an example of transition of pressure and temperature in a pressure vessel during CIP processing.

FIG. 5 is a diagram illustrating an example of a physical quantity of a workpiece.

FIG. 6 is a diagram illustrating an example of a physical quantity of the workpiece.

FIG. 7 is a diagram illustrating an example of a physical quantity of the workpiece.

FIG. 8 is a flowchart illustrating an example of processing in the machine-learning system illustrated in FIG. 2.

FIG. 9 is an overall configuration diagram of a machine-learning system according to a modified embodiment of the present invention.

### DESCRIPTION OF EMBODIMENTS

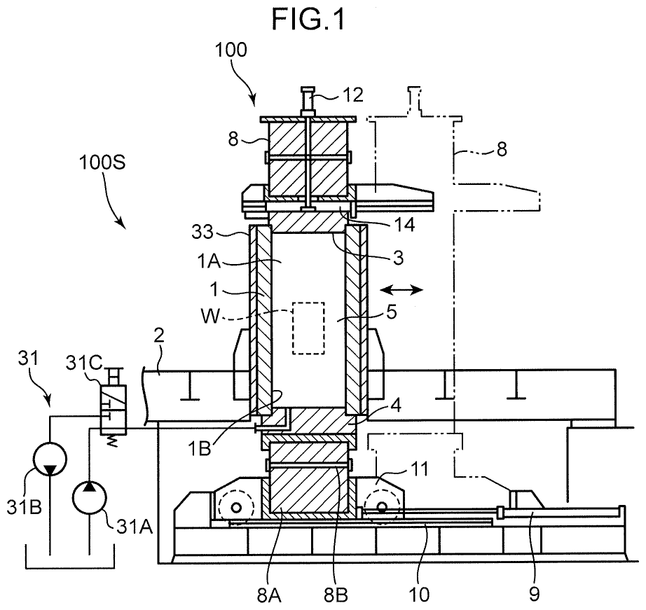

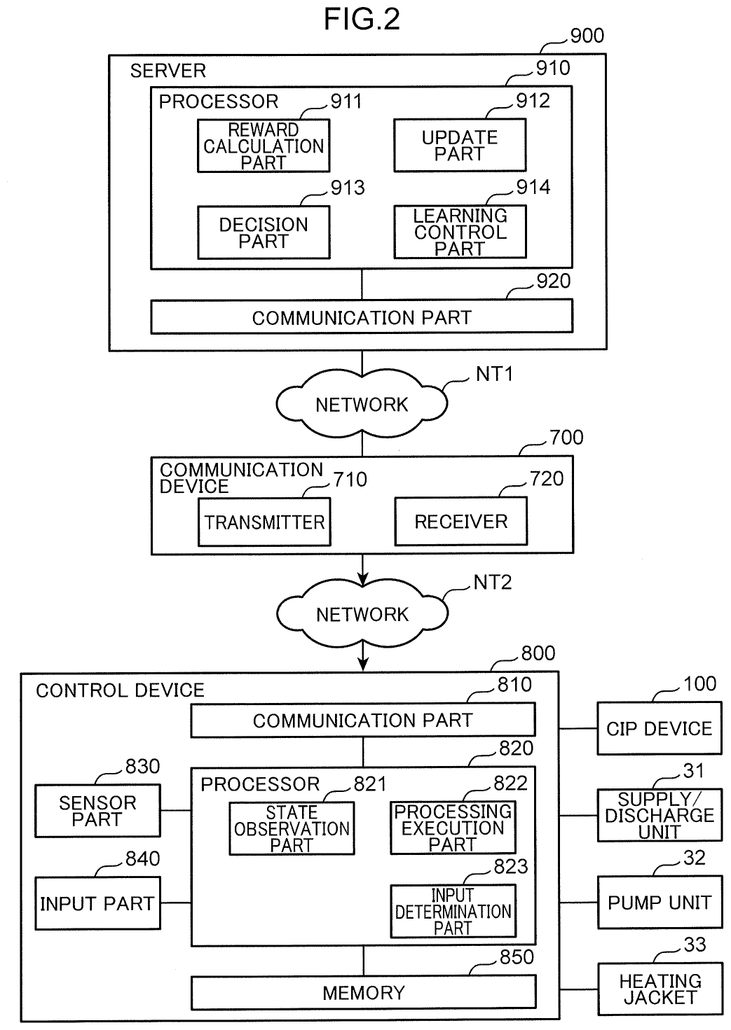

In the following, a CIP system 100S (isostatic pressurization system) including a CIP device 100 (isostatic pressurization device, cold isostatic pressurization device, warm isostatic pressurization device) according to an embodiment of the present invention will be described with reference to the drawings. FIG. 1 is an overall configuration view of the CIP system 100S to be a learning target in the embodiment of the present invention. FIG. 2 is an overall configuration diagram of a machine-learning system that causes the CIP system 100S according to the present embodiment to perform machine-learning. The CIP system 100S performs isostatic pressurization processing on a workpiece using a pressure medium. In particular, in the present embodiment, the CIP system 100S performs wet cold isostatic pressurization processing.

Although in the following description, a workpiece to be processed is powder such as ceramics, the workpiece may be other than such powder.

The CIP system 100S includes the CIP device 100 including a pressure vessel 1, a supply/discharge unit 31, a pump unit 32, a heating jacket 33, and a control device 800 to be described later.

The CIP device 100 is configured by a cold isostatic pressurization device or a warm isostatic pressurization device. The pressure vessel 1 stores a workpiece. The CIP device 100 performs the isostatic pressurization processing on a workpiece W. The pressure vessel 1 has a cylindrical shape, and is configured by shrink fitting or the like a single cylindrical body or multiple inner and outer cylindrical bodies. The pressure vessel 1 is vertically placed along an up-down direction with its trunk fixed to a stand 2. Upper and lower ends of the pressure vessel 1 are opened, and an upper opening 1A and a lower opening 1B are formed. An upper lid 3 and a lower lid 4 each having liquid-tight packing are fitted to the upper opening 1A and the lower opening 1B, respectively, and a processing chamber 5 (processing space) is defined in the pressure vessel 1.

The supply/discharge unit 31 introduces a liquid (water) pressure medium into the processing chamber 5 and discharges the liquid from the processing chamber 5. In the present embodiment, water, cold water, and hot water are used as the pressure medium. The water supply/discharge unit 31 functions as a compressor of the present invention. Specifically, the supply/discharge unit 31 includes a supply pump 31A for supply and a discharge pump 31B, and has a switching valve 31C in the middle of the circuit. The workpiece W is housed in the processing chamber 5. The workpiece W can be isostatically pressurized with the pressure medium by pressurization by driving of the pump unit 32 (FIG. 2), and a press frame 8 can carry an axial force generated in the upper lid 3 and the lower lid 4 at the time of pressurization.

In the present embodiment, the pressure medium is supplied to the processing chamber 5, and at the same time, the pressure medium is pressurized by the pump unit 32. The pump unit 32 functions as a pressure adjustment mechanism of the present invention. The pump unit 32 is capable of adjusting a pressure in the pressure vessel 1.

When the workpiece W is powder such as ceramics, the workpiece W is packed in a rubber mold. The press frame 8 can be freely engaged with and disengaged from the upper lid 3 and the lower lid 4, and illustrated in FIG. 1 is the press frame 8 in which a frame element 8A having an opening is stacked and fastened by a tie rod 8B on a cart 11 that reciprocates on a rail 10 by an extensible cylinder 9.

In addition, an extensible cylinder 12 for opening and closing the upper lid 3 is provided on an upper part of the press frame 8, and the upper lid 3 is allowed to be fitted to and removed from the upper opening 1A by extension and contraction of the extensible cylinder 12. Therefore, a cotter member 14 that can be freely taken in and out by a cylinder outside the circumference is provided between an upper inner peripheral end plate 13 of the press frame 8 and an upper end surface of the upper lid 3, so that the upper lid 3 is pulled out from the upper opening 1A in a state where the cotter member 14 is retracted, and the press frame 8 can be detached as indicated by a chain line in FIG. 1. After the workpiece W is housed in the processing chamber 5, a press axial force can be carried by advancing the press frame 8 again and making the cotter member 14 to intervene.

With the heating jacket 33 (FIG. 2) disposed outside the pressure vessel 1, by circulating a heating medium heated by an external heating unit in the heating jacket 33 to heat the pressure medium in the pressure vessel 1, the workpiece can be preheated or heated before or during the pressurization processing on the workpiece W. In addition, a temperature of the heating medium circulated in the heating jacket 33 can be measured by a thermocouple of a heating unit (not illustrated) that heats the heating medium, and the calorific value can be adjusted according to the temperature detection result. The heating jacket 33 functions as a temperature adjustment mechanism of the present invention. The heating jacket 33 is capable of adjusting temperature of the pressure medium in the pressure vessel 1. In the present embodiment, the temperature of the pressure medium in the pressure vessel 1 is lower than a temperature (a high temperature of several 100 degrees to 2000 degrees) of a pressure medium in a known HIP (hot isostatic pressing) device, and is 100 degrees or less as an example. In a case where water of normal temperature is used as the pressure medium, as an example, the temperature is around 20 degrees.

The control device 800 controls each operation of the water supply/discharge unit 31, the pump unit 32, the heating jacket 33, a drive mechanism of the CIP device 100, a drive cylinder, the heating unit, and the like. The control device 800 has an operation panel (not illustrated). The control device 800 is configured by a computer and performs overall control of the CIP device 100.

In the CIP device 100 as described above, when the isostatic pressurization processing is performed on the workpiece W, first, the CIP device 100 including the pressure vessel 1 is prepared (a preparation process). A worker houses the workpiece W such as ceramic powder in the pressure vessel 1 (a workpiece housing process). At this time, the pressure medium (or the workpiece) in the pressure vessel 1 may be heated (preheated) to, for example, about 80° C. by the heating jacket 33.

Next, the control device 800 controls the supply/discharge unit 31 in response to an operation command from the worker, so that water of normal temperature (e.g., 20° C.) is supplied from the supply/discharge unit 31 into the processing chamber 5 of the pressure vessel 1. The water is filled until the processing chamber 5 of the pressure vessel 1 is filled.

Next, the control device 800 controls the pump unit 32 to pressurize the water in the processing space (isostatic pressurization processing, pressurization processing process). At this time, since a volume of the water in the processing space is reduced by pressurization, it is desirable to additionally supply water of normal temperature. By applying a high pressure to the workpiece W in the pressure vessel 1 for a predetermined time, the ceramic powder is molded according to a shape of the rubber mold. During the pressurization, the pressure medium (workpiece) in the pressure vessel 1 may be heated by the heating jacket 33.

When the pressurization processing is completed, decompression processing is performed on the processing space. Specifically, the pressure medium is discharged from the pressure vessel 1, and the inside of the pressure vessel 1 is decompressed (decompression processing process).

Thereafter, the press frame 8 is moved to a position indicated by a chain double-dashed line in FIG. 1, and the worker takes out the workpiece W subjected to the pressurization processing from the pressure vessel 1.

With reference to FIG. 2, a machine-learning system (machine-learning device) includes a server 900 (management device) and a communication device 700 in addition to the control device 800 described in FIG. 1. The server 900 and the communication device 700 are communicably connected to each other via a network NT1. The communication device 700 and the control device 800 are communicably connected to each other via a network NT2. The network NT1 is, for example, a wide-area communication network such as the Internet. The network NT2 is, for example, a local area network. The server 900 is, for example, a cloud server configured by one or more computers. The communication device 700 is, for example, a computer owned by a user who uses the control device 800. The communication device 700 functions as a gateway that connects the control device 800 to the network NT1. The communication device 700 is realized by installing dedicated application software in the computer owned by the user. Alternatively, the communication device 700 may be a dedicated device that is provided to the user by a manufacturer of the CIP device 100. The control device 800 is a control device that controls the CIP device 100 described above with reference to FIG. 1.

In the following, a configuration of each device will be specifically described. The server 900 includes a processor 910 and a communication part 920. The processor 910 is a control device including a CPU and the like. The processor 910 includes a reward calculation part 911, an update part 912, a decision part 913, and a learning control part 914. These functional parts represent units of functions executed by the processor 910. Each block included in the processor 910 may be realized by the processor 910 executing a machine-learning program for causing a computer to function as the server 900 in the machine-learning system, or may be realized by a dedicated electric circuit.

The reward calculation part 911 calculates a reward for a decision result of at least one CIP processing condition based on a state variable observed by a state observation part 821.

The update part 912 updates a function for deciding a CIP processing condition from the state variable observed by the state observation part 821 based on the reward calculated by the reward calculation part 911. As the function, an action value function to be described later is adopted.

While changing at least one CIP processing condition, the decision part 913 decides a CIP processing condition that maximizes a reward by repeating updating of the function.

The learning control part 914 is in charge of overall control of machine-learning. The machine-learning system according to the present embodiment learns CIP processing conditions by reinforcement learning. The reinforcement learning is a machine-learning method in which an agent (action subject) selects a certain action based on a situation of an environment, changes the environment based on the selected action, and a reward associated with the environment change is given to the agent, thereby causing the agent to learn to select a better action. As the reinforcement learning, Q learning and TD learning can be adopted. In the following description, Q learning will be described as an example. In the present embodiment, the reward calculation part 911, the update part 912, the decision part 913, the learning control part 914, and the state observation part 821 to be described later correspond to agents. In the present embodiment, the communication part 920 is an example of a state acquisition part that acquires a state variable.

The communication part 920 is configured by a communication circuit that connects the server 900 to the network NT1. The communication part 920 receives a state variable observed by the state observation part 821 via the communication device 700. The communication part 920 transmits a CIP processing condition decided by the decision part 913 to the control device 800 via the communication device 700.

The communication device 700 includes a transmitter 710 and a receiver 720. The transmitter 710 transmits a state variable transmitted from the control device 800 to the server 900, and transmits a CIP processing condition transmitted from the server 900 to the control device 800. The receiver 720 receives a state variable transmitted from the control device 800 and receives a CIP processing condition transmitted from the server 900.

The control device 800 includes a communication part 810, a processor 820, a sensor part 830, an input part 840, and a memory 850.

The communication part 810 is a communication circuit for connecting the control device 800 to the network NT2. The communication part 810 transmits a state variable observed by the state observation part 821 to the server 900. The communication part 810 receives a CIP processing condition decided by the decision part 913 of the server 900. The communication part 810 receives a CIP processing execution command (to be described later) decided by the learning control part 914.

The processor 820 is a computer including a CPU and the like. The processor 820 includes the state observation part 821, a processing execution part 822, and an input determination part 823. The communication part 810 transmits a state variable acquired by the state observation part 821 to the server 900. Each block included in the processor 820 is realized by, for example, the CPU executing a machine-learning program causing the machine-learning system to function as the control device 800.

The state observation part 821 acquires a physical quantity detected by the sensor part 830 after execution of the CIP processing. The state observation part 821 observes a state variable including at least one physical quantity related to the workpiece W and at least one CIP processing condition after execution of the CIP processing. Specifically, the state observation part 821 acquires the CIP processing condition based on a measurement value of the sensor part 830. In addition, the state observation part 821 acquires a physical quantity based on the measurement value of the sensor part 830 or the like. In the present embodiment, at least one physical quantity related to the workpiece W is a physical quantity related to densification and green compaction.

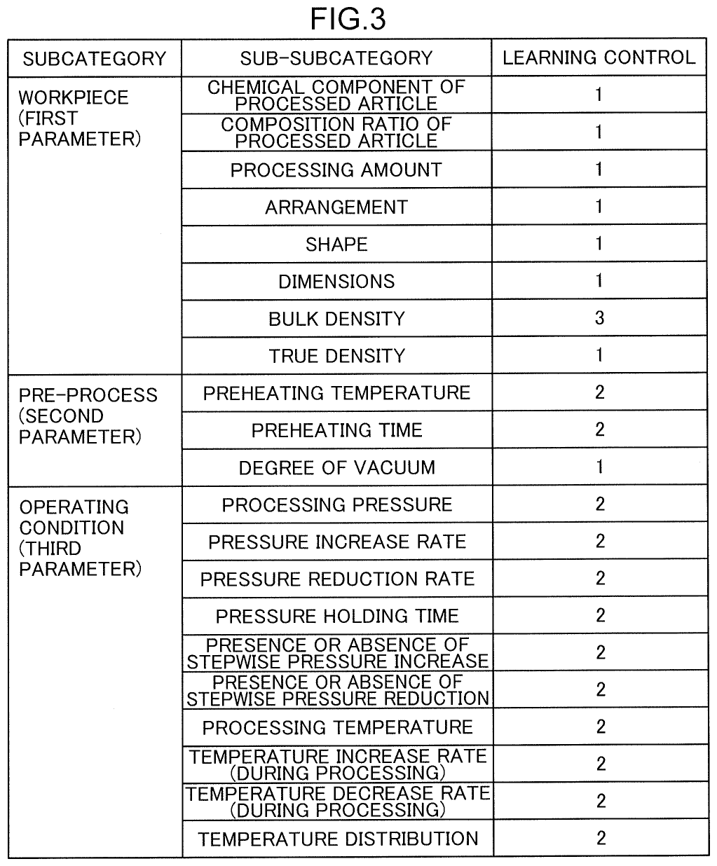

FIG. 3 is a diagram illustrating an example of CIP processing conditions. The CIP processing conditions are roughly classified into subcategories. The subcategory includes at least one of a first parameter related to a workpiece, a second parameter related to a pre-process of the CIP processing, and a third parameter related to an operating condition of the CIP device 100. In a column of learning control in the Table, a parameter recited as “1” is a parameter that designates a value by a user operating the input part 840, and is not a parameter learned by machine-learning. Therefore, in the present embodiment, a parameter other than “1”, i.e., recited as “2”, is to be a learning target. Note that “bulk density” recited as “3” may be a learning target according to a device configuration of the CIP device 100. However, these classifications are merely examples, and any one or more parameters among the parameters recited as “1” may be set as the learning targets.

The first parameter includes, as a sub-subcategory, at least one of a chemical component of a processed article, a composition ratio of the processed article, a processing amount, an arrangement, a shape, dimensions, a bulk density, and a true density. The chemical component and the composition ratio of a processed article indicate a chemical component and a composition ratio of a material constituting the workpiece W. For example, the chemical component is Ti, Al, Fe, or the like. In addition, for example, the composition ratio is set to Ti: 80 wt %, Al: 10 wt %, Fe: 10 wt %, or the like. The processing amount indicates an amount to be processed per batch, i.e., an amount of the workpiece W housed in the pressure vessel 1 in one CIP processing. The arrangement indicates how the workpiece W is arranged in the pressure vessel 1. The shape is an outer shape of the workpiece W. As described above, when the workpiece W is ceramic powder, the workpiece exhibits a shape of the rubber mold. For example, information such as cylinder, column, rectangular parallelepiped, sphere, truncated cone, and polygonal column can be adopted as the shape. The reason why the shape is thus added to the CIP processing conditions is that a result of the CIP processing may change depending on a shape of the workpiece W. For the dimensions, information such as width, height, and depth is adopted when the workpiece W is a rectangular parallelepiped, and information such as average diameter and height is adopted when the workpiece W has a cylindrical shape. The bulk density means a bulk density in a case where the workpiece W is powder. The true density indicates an actual density of the workpiece W. Note that in another embodiment, assuming the shape and dimensions of the workpiece to be parameters learned by machine-learning, these can be observed using, for example, a camera, a three-dimensional measuring instrument, or the like.

As described above, each of the chemical component, the composition ratio, the processing amount, the arrangement, the shape, the dimensions, the bulk density, and the true density is input by the user via the input part 840. Therefore, the state observation part 821 may acquire these parameters from the input part 840.

The second parameter includes, as a sub-subcategory, a preheating temperature, a preheating time, and a degree of vacuum at the time of vacuum packaging (degree of vacuum in FIG. 3). The preheating temperature indicates a temperature in preheating processing performed on the workpiece W before the CIP processing (pressurization processing). Similarly, the preheating time indicates a time in the preheating processing performed on the workpiece W before the CIP processing. The degree of vacuum at the time of vacuum packaging indicates a degree of vacuum at the time of vacuum packaging the workpiece W. These second parameters are input by the user via the input part 840. Therefore, the state observation part 821 may acquire these parameters from the input part 840. A preheating process, which is a pre-process, may be performed on the workpiece W stored in the pressure vessel 1 or may be performed on the workpiece W outside the pressure vessel 1. In any case, the preheating temperature and the preheating time constitute the second parameter of the present invention.

The third parameter includes, as a sub-subcategory, a processing pressure, a pressure increase rate, a pressure reduction rate, a pressure holding time, presence or absence of stepwise pressure increase, presence or absence of stepwise pressure reduction, a processing temperature, a temperature increase rate (during processing), a temperature decrease rate (during processing), and a temperature distribution. The processing pressure indicates a pressure in the pressure vessel 1 during the CIP processing. The pressure increase rate and the pressure reduction rate indicate speeds in pressure changes before and after the CIP processing. The pressure reduction rate also includes secondary decompression. Specifically, the pressure reduction rate changes at a preset secondary decompression setting value or less. The pressure holding time indicates a time for performing the CIP processing on the workpiece W. The presence or absence of stepwise pressure increase indicates whether or not pressure increase until reaching a constant processing pressure is performed in a stepwise manner during the CIP processing. Similarly, the presence or absence of stepwise pressure reduction indicates whether or not pressure reduction from the constant processing pressure is performed in a stepwise manner during the CIP processing. The processing temperature indicates a temperature in the pressure vessel 1 during the CIP processing. The temperature increase rate (during processing) indicates a speed of temperature increase in the pressure vessel 1 during the CIP processing. Similarly, the temperature decrease rate (during processing) indicates a speed of temperature decrease in the pressure vessel 1 during the CIP processing. The temperature distribution indicates a temperature distribution in the pressure vessel 1 formed by adjusting the calorific value of each heating jacket 33 when a plurality of heating jackets 33 is disposed along a predetermined direction in the pressure vessel 1.

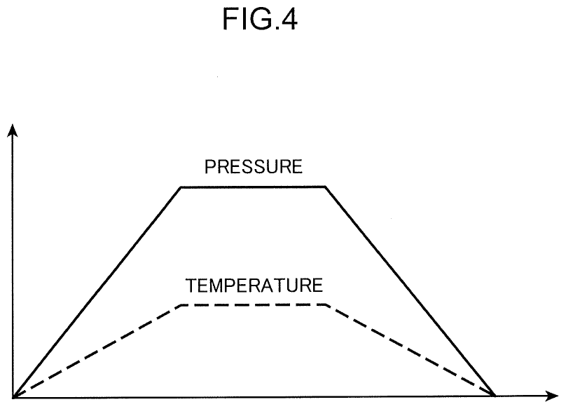

FIG. 4 is a graph illustrating a graph that shows an example of transition of pressure and temperature in the pressure vessel 1 during the CIP processing. In FIG. 4, a vertical axis represents pressure and temperature, and a horizontal axis represents time. In this example, transitions of both the pressure and the temperature are trapezoidal. The pressure and temperature increase at a constant gradient until reaching a maximum pressure and a maximum temperature, respectively, and decrease at a constant gradient after maintaining the maximum pressure (processing pressure) and the maximum temperature (processing temperature) for a certain period of time. Regarding pressure, as described above, the processing pressure, a gradient at the time of pressure increase (pressure increase rate), a gradient at the time of pressure reduction (pressure reduction rate), a maintaining time of the maximum pressure (pressure holding time), the presence or absence of stepwise pressure increase and stepwise pressure reduction, and the like are changed to perform the machine-learning. In addition, regarding temperature, the processing temperature, a gradient at the time of increase (temperature increase rate), a gradient at the time of decrease (temperature decrease rate), a maintenance period of the maximum temperature, the temperature distribution, and the like are changed to perform the machine-learning. For the operating condition related to the pressure, data input by the user via the input part 840 may be adopted, or a measurement value of a pressure sensor (not illustrated) of the water supply/discharge unit 31 may be adopted. Data input by the user via the input part 840 is adopted as the other parameters.

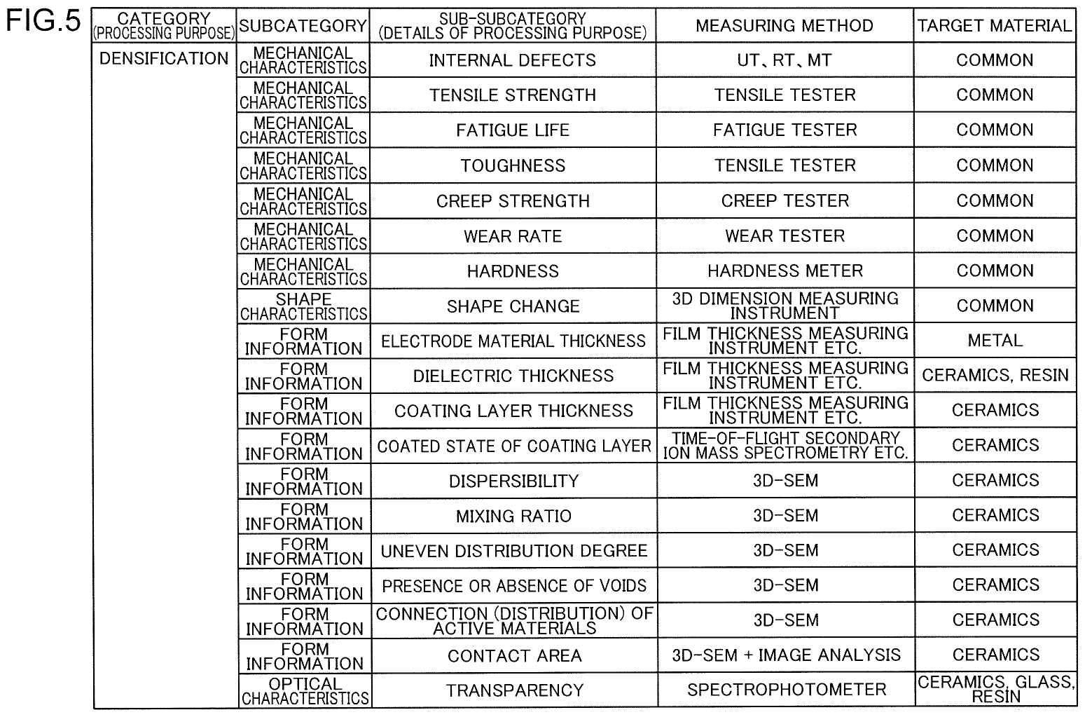

FIGS. 5, 6, and 7 are diagrams illustrating examples of physical quantities of the workpiece W. As a category, the physical quantities are classified into physical quantities related to densification and green compaction.

Densification is roughly classified into subcategories including mechanical characteristics, shape characteristics, form information, optical characteristics, electrical characteristics, and physical characteristics.

The mechanical characteristics as the subcategory is classified into a plurality of sub-subcategories according to a processing purpose. The sub-subcategories include internal defects, a tensile strength, a fatigue life, a toughness, a creep strength, a wear rate, and a hardness. Each sub-subcategory of the mechanical characteristics is a classification that can be commonly applied to each material regardless of a target material.

The internal defects as the sub-subcategory indicates presence or absence of an internal defect of the workpiece W subjected to the pressurization processing. For the internal defects, a known UT method (ultrasonic testing method), RT method (radiographic testing method), or MT method (magnetic particle testing method) can be adopted.

The tensile strength as the sub-subcategory indicates a tensile strength of the workpiece W subjected to the pressurization processing. The tensile strength can be tested with a known tensile tester.

The fatigue life as the sub-subcategory indicates a fatigue life of the workpiece W subjected to the pressurization processing. The fatigue life can be tested with a known fatigue tester.

The toughness as the sub-subcategory indicates a toughness of the workpiece W subjected to the pressurization processing. The toughness can be tested with a known tensile tester.

The creep strength as the sub-subcategory indicates a creep strength of the workpiece W subjected to the pressurization processing. The creep strength can be tested with a known creep tester.

The wear rate as the sub-subcategory indicates a wear rate of the workpiece W subjected to the pressurization processing. The wear rate can be tested with a known wear tester.

The hardness as the sub-subcategory indicates a hardness of the workpiece W subjected to the pressurization processing. The hardness can be measured with a known hardness meter.

The shape characteristics as the subcategory includes a sub-subcategory of a shape change. The shape change as the sub-subcategory means a change in the shape of the workpiece W subjected to the pressurization processing. The shape change over time can be measured by a known 3D dimension measuring instrument.

The form information as the subcategory is classified into sub-subcategories of an electrode material thickness, a dielectric thickness, an active material-solid electrolyte coating layer thickness (coating layer thickness in FIG. 5), a coated state of active material-solid electrolyte coating layer (coated state of coating layer in FIG. 5), a dispersibility of positive electrode mixture/solid electrolyte (dispersibility in FIG. 5), a mixing ratio of positive electrode mixture/solid electrolyte (mixing ratio in FIG. 5), an uneven distribution degree of positive electrode mixture/solid electrolyte (uneven distribution degree in FIG. 5), a presence or absence of voids, a connection (distribution) of active materials, and a contact area of active material/solid electrolyte (contact area in FIG. 5).

The electrode material thickness as the sub-subcategory is mainly adopted when the workpiece W is made of metal, and can be measured by a known film thickness measuring instrument, cross-sectional SEM (scanning electron microscope), or AFM (atomic force microscope).

The dielectric thickness as the sub-subcategory is mainly adopted when the workpiece W is made of ceramics or resin, and similarly, can be measured by a known film thickness measuring instrument, a cross-sectional SEM (scanning electron microscope), or an AFM (atomic force microscope).

The active material-solid electrolyte coating layer thickness as the sub-subcategory is mainly adopted when the workpiece W is made of ceramics, and similarly, can be measured by a known film thickness measuring instrument, a cross-sectional SEM (scanning electron microscope), or an AFM (atomic force microscope).

The coated state of active material-solid electrolyte coating layer as the sub-subcategory is mainly adopted when the workpiece W is made of ceramics, and can be measured by a known time-of-flight secondary ion mass spectrometry, TEM-EDX (energy dispersive X-ray spectroscopy), or low speed ion scattering spectroscopy.

Each of the dispersibility of positive electrode mixture/solid electrolyte, the mixing ratio of positive electrode mixture/solid electrolyte, the uneven distribution degree of positive electrode mixture/solid electrolyte, the presence or absence of voids, the connection (distribution) of active materials, and the contact area of active material/solid electrolyte as the sub-subcategory is mainly adopted when the workpiece W is made of ceramics, and can be measured by a known 3D-SEM. The contact area of active material/solid electrolyte can be measured by combining image analysis with 3D-SEM.

The optical characteristics as the subcategory includes a sub-subcategory of a transparency. The transparency is mainly employed when the workpiece W is made of ceramics, glass, resin, or the like, and can be measured by a known spectrophotometer.

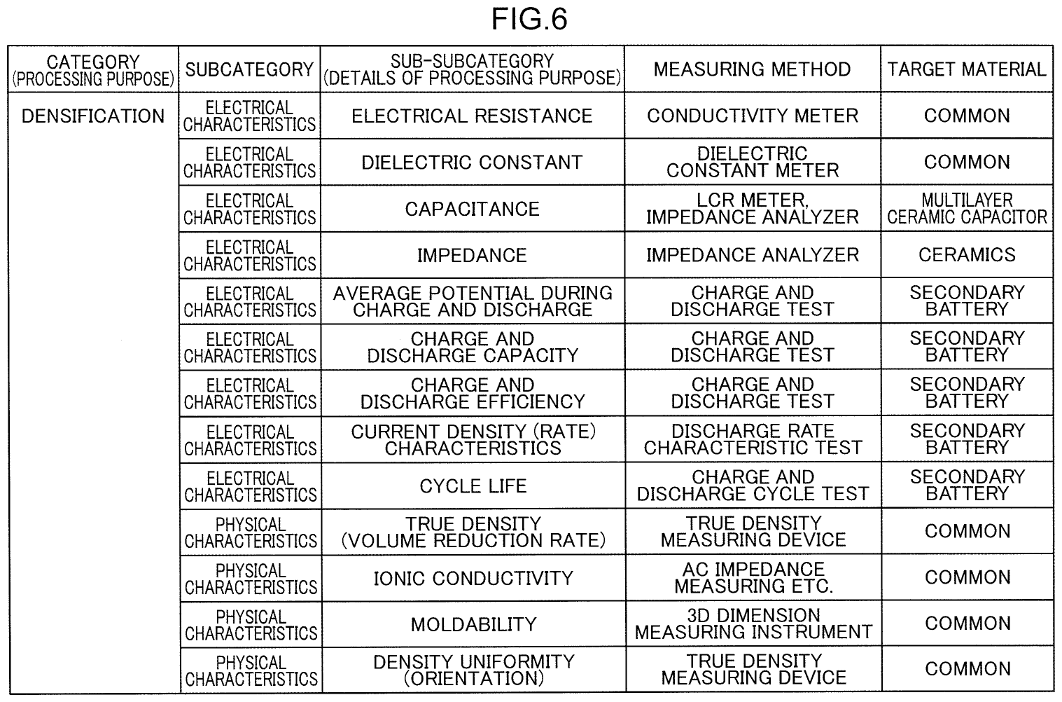

With reference to FIG. 6, the electrical characteristics as the subcategory is classified into sub-subcategories of an electrical resistance, a dielectric constant, a capacitance, an impedance, an average potential during charge and discharge, a charge and discharge capacity, a charge and discharge efficiency, current density (rate) characteristics, and a cycle life.

The electrical resistance as the sub-subcategory means an electrical resistance of the workpiece W subjected to the pressurization processing, and is applicable to a common target material. The electrical resistance can be measured by a known conductivity meter.

The dielectric constant as the sub-subcategory means a dielectric constant of the workpiece W subjected to the pressurization processing, and is applicable to a common target material. The dielectric constant can be measured by a known dielectric constant meter as well.

The capacitance as the sub-subcategory means a capacitance of the workpiece W subjected to the pressurization processing, and is applied when the target material is a multilayer ceramic capacitor. The capacitance can be measured by a known LCR meter or impedance analyzer.

The impedance as the sub-subcategory means an impedance of the workpiece W subjected to the pressurization processing, and is mainly applied when the workpiece W is made of ceramics. The impedance can be measured by a known impedance analyzer.

Each of the average potential during charge and discharge, the charge and discharge capacity, and the charge and discharge efficiency as the sub-subcategory is mainly applied when the target material is a secondary battery. These can be measured by a charge and discharge tester (battery tester).

Each of the current density (rate) characteristics and the cycle life as the sub-subcategory is also mainly applied when the target material is a secondary battery. The current density characteristics can be acquired by a discharge rate characteristic test. The cycle life can be measured by a charge and discharge cycle test.

The physical characteristics as the subcategory is classified into sub-subcategories of a true density (volume reduction rate), an ionic conductivity, a moldability, and a density uniformity (orientation), and any of them can be applied to any target member.

The true density (volume reduction rate) can be measured by a true density measuring device. The ionic conductivity can be measured by an AC impedance measuring device, an FFT (fast Fourier transform) analyzer, or an FRA (frequency response analysis) method. In addition, the moldability can be measured by a 3D dimension measuring instrument. Furthermore, the density uniformity can be acquired by measuring the workpiece W at a plurality of places using a true density measuring device.

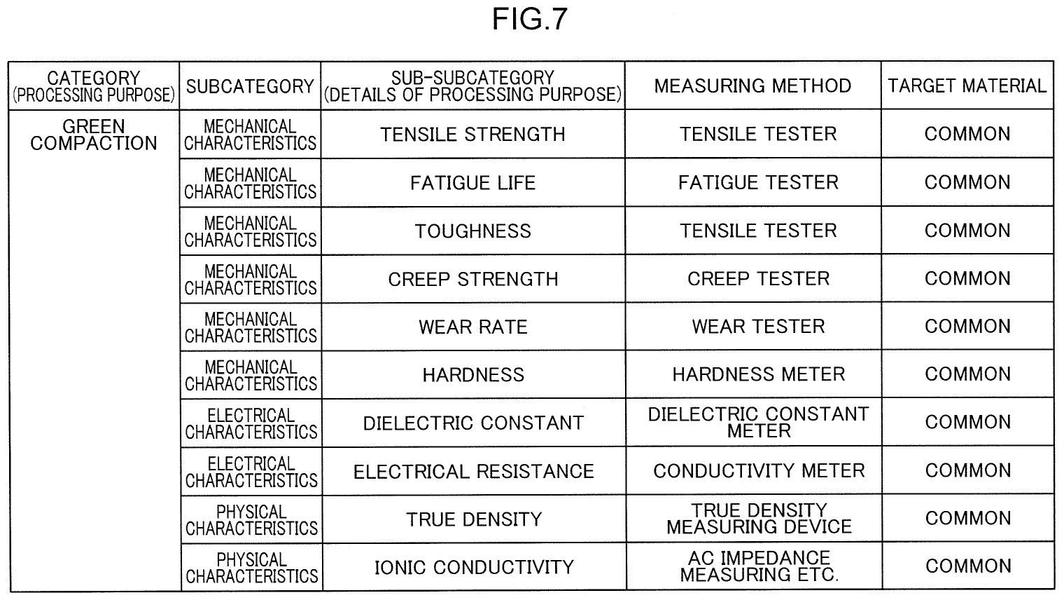

With reference to FIG. 7, the category of the green compaction is classified into subcategories of the mechanical characteristics, the electrical characteristics, and the physical characteristics. The mechanical characteristics as the subcategory is classified into sub-subcategories of the tensile strength, the fatigue life, the toughness, the creep strength, the wear rate, the hardness, and the like: the electrical characteristics as the subcategory is classified into sub-subcategories of the dielectric constant, the electrical resistance, and the like; and the physical characteristics as the subcategory is classified into sub-subcategories of the true density, the ionic conductivity, and the like. Since these sub-subcategories are similar to those included in the above-described category of the densification, description thereof will be omitted.

Reference is returned to FIG. 2. The processing execution part 822 controls execution of the CIP processing by the CIP device 100. The input determination part 823 automatically or manually determines whether it is a mass production process or not. In a case of automatically determining whether it is a mass production process or not, when the number of times of input of a condition number input to the input part 840 exceeds a reference number, the input determination part 823 determines that the CIP device 100 is in the mass production process. The condition number is an identification number for specifying a certain CIP processing condition. A CIP processing condition specified by the condition number includes at least a CIP processing condition recited as “1” among the CIP processing conditions illustrated in FIG. 3.

In a case of manually determining whether it is the mass production process or not, when data indicating the mass production process is input to the input part 840, the input determination part 823 determines that the CIP device 100 is in the mass production process. In the mass production process, the control device 800 does not perform machine-learning.

The memory 850 is, for example, a nonvolatile storage device, and stores a finally determined optimum CIP processing condition and the like.

The sensor part 830 is configured by various sensors for use in measuring the CIP processing conditions illustrated in FIG. 3 and the physical quantities of the workpiece W illustrated in FIGS. 5, 6, and 7. Specifically, the sensor part 830 includes a temperature sensor that measures a temperature in the pressure vessel 1, a pressure sensor, and the like. In addition, the sensor part 830 includes a sensor for performing the above-described various measurement tests on the workpiece W taken out from the pressure vessel 1 after the completion of the CIP processing on the workpiece W. Although in FIG. 2, the sensor part 830 is provided inside the control device 800, this is an example, and the sensor part 830 may be provided outside the control device 800, and an installation location thereof is not particularly limited. The input part 840 is an input device such as a keyboard and a mouse.

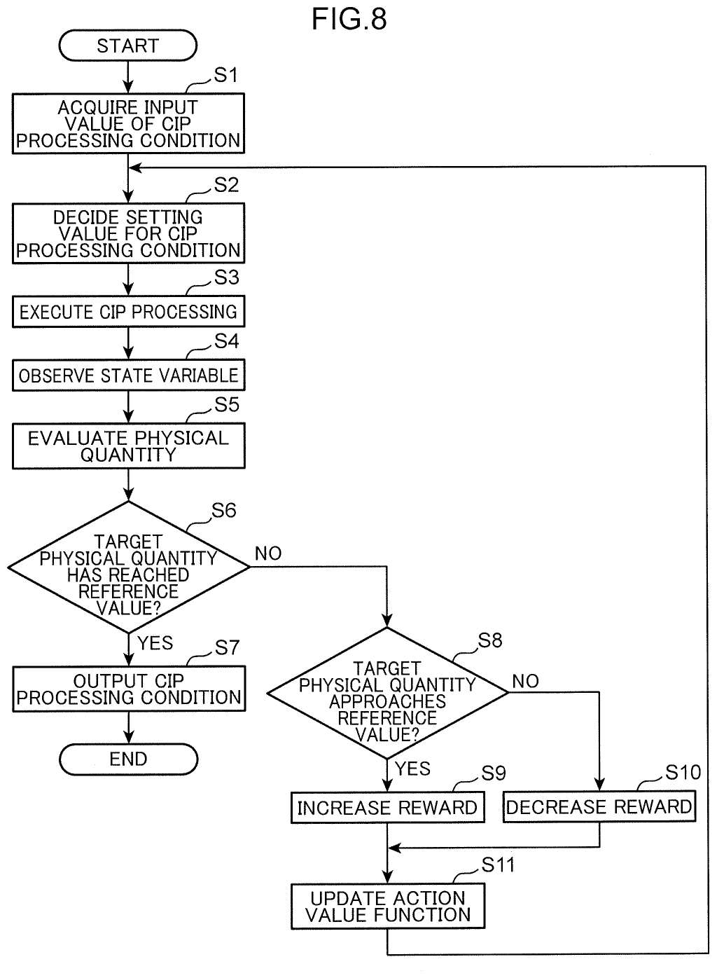

FIG. 8 is a flowchart illustrating an example of processing executed by the machine-learning system illustrated in FIG. 2. In Step S1, the learning control part 914 acquires an input value of a CIP processing condition input by the user using the input part 840. The input value acquired here is an input value for the CIP processing condition recited as “1” among the CIP processing conditions listed in FIG. 3.

In Step S2, the learning control part 914 decides at least one CIP processing condition and a setting value for the CIP processing condition. Here, the CIP processing condition to be set is a CIP processing condition recited as “2” or “3” among the CIP processing conditions listed in FIG. 3, and is at least one CIP processing condition whose setting value can be set. Here, the setting value of the decided CIP processing condition corresponds to an action in reinforcement learning.

Specifically, the learning control part 914 randomly selects a setting value for each CIP processing condition to be set. Here, the setting value is randomly selected from a predetermined range for each of the CIP processing conditions. As a method of selecting the setting value of the CIP processing condition, for example, an E-greedy method can be adopted.

In Step S3, the learning control part 914 transmits a CIP processing execution command to the control device 800 to cause the CIP device 100 to start the CIP processing through the control device 800. When the CIP processing execution command is received by the communication part 810, the processing execution part 822 sets a CIP processing condition according to the CIP processing execution command and starts the CIP processing. The CIP processing execution command includes the input value of the CIP processing condition set in Step S1, the setting value of the CIP processing condition decided in Step S2, and the like.

When the CIP processing is completed, the state observation part 821 observes the state variable (Step S4). Specifically, the state observation part 821 acquires, as state variables, the physical quantities related to densification and green compaction recited in FIGS. 5, 6, and 7 and the CIP processing conditions under which the state is observed by the sensor part 830 or the like among the CIP processing conditions recited in FIG. 3. The physical quantity may be input to the control device 800 by, for example, the user operating the input part 840, or may be input to the control device 800 by communication between a measuring instrument that measures the physical quantity and the control device 800. The state observation part 821 transmits the acquired state variable to the server 900 via the communication part 810.

In Step S5, the decision part 913 evaluates the physical quantity. Here, the decision part 913 evaluates the physical quantity by determining whether or not the physical quantity to be evaluated (hereinafter, referred to as a target physical quantity) among the physical quantities acquired in Step S4 has reached a predetermined reference value. The target physical quantity is one or more physical quantities among the physical quantities listed in FIGS. 5, 6, and 7. In a case where there are a plurality of target physical quantities, there will be a plurality of reference values corresponding to the respective target physical quantities. As the reference value, for example, a predetermined value indicating that the target physical quantity has reached a certain reference can be adopted.

For example, when machine-learning is performed on the tensile strength of densification, a predetermined value for the tensile strength is adopted as the reference value, and when machine-learning is performed on the toughness, a predetermined value for the toughness is adopted as the reference value. The reference value may be, for example, a value including an upper limit value and a lower limit value. In this case, when the target physical quantity falls within a range between the upper limit value and the lower limit value, it is determined that the target physical quantity has reached the reference value. The reference value may be one value. In this case, when the target physical quantity exceeds the reference value or falls below the reference value, it is determined that a certain standard is satisfied.

When determining that the target physical quantity has reached the reference value (YES in Step S6), the decision part 913 outputs the CIP processing condition set in Step S2 as a final CIP processing condition (Step S7). On the other hand, when the decision part 913 determines that the physical quantity has not reached the reference value (NO in Step S6), the processing proceeds to Step S8. Note that in a case where there are a plurality of target physical quantities, the decision part 913 may determine YES in Step S6 when all the target physical quantities have reached the reference value.

In Step S8, the reward calculation part 911 determines whether or not the target physical quantity approaches the reference value. In a case where the target physical quantity approaches the reference value (YES in Step S8), the reward calculation part 911 increases a reward for the agent (Step S9). On the other hand, when the target physical quantity does not approach the reference value (NO in Step S8), the reward calculation part 911 decreases the reward for the agent (Step S10). In this case, the reward calculation part 911 may increase or decrease the reward according to a predetermined increase/decrease value of the reward. Note that in a case where there are a plurality of target physical quantities, the reward calculation part 911 may perform the determination in Step S8 for each of the plurality of target physical quantities. In this case, the reward calculation part 911 may increase or decrease the reward for each of the plurality of target physical quantities based on the determination result of Step S8. In addition, a different value may be adopted as the increase/decrease value of the reward according to the target physical quantity.

In addition, when the target physical quantity does not approach the reference value (NO in Step S8), the processing of decreasing the reward may be omitted (Step S10). In this case, the reward will be given only when the target physical quantity approaches the reference value.

In Step S11, the update part 912 updates an action value function using the reward given to the agent. The Q learning adopted in the present embodiment is a method of learning a Q value (Q(s, a)) which is a value for selecting an action a under a certain environmental state s. Note that an environmental state sₜ corresponds to the state variable of the above flow: Then, in the Q learning, an action a with the highest Q(s, a) is selected in the certain environmental state s. In the Q learning, various actions a are taken under the certain environmental state s by trial and error, and a correct Q(s, a) is learned using the reward at that time. An update equation of the action value function Q(sₜ, aₜ) is expressed by the following Equation (1).

$$\begin{matrix}[ Equation 1 ] & \\ Q ( {s}_{t} , {a}_{t} ) ← Q ( {s}_{t} , {a}_{t} ) + α ( {r}_{t + 1} + γ {max}_{a} Q ( {s}_{t + 1} , a ) - Q ( {s}_{t} , {a}_{t} ) ) & ( 1 )\end{matrix}$$

Here, sₜ and a represent an environmental state and an action at time t, respectively. The environmental state changes to sₜ₊₁ by the action aₜ, and a reward rₜ₊₁ is calculated by the change of the environmental state. In addition, a term with max is obtained by multiplying a Q value (Q(sₜ₊₁, a)) by γ, the Q value being as of a case where the most valuable action a known at that time is selected under the environmental state sₜ₊₁. Here, γ is a discount rate, and has a value of 0<γ≤1 (ordinarily 0.9 to 0.99). α is a learning coefficient and has a value of 0<α≤1 (ordinarily about 0.1).

In this update equation, when γ·max Q(sₜ₊₁, a) based on the Q value at the time of taking the best action in the next environmental state sₜ₊₁ by the action a is larger than Q(sₜ, aₜ) which is a Q value of the action a in the state s, Q(sₜ, aₜ) is increased. On the other hand, in this update equation, if γ·max Q(sₜ₊₁, a) is smaller than Q(sₜ, aₜ), Q(sₜ, aₜ) is made smaller. In other words, a value of a certain action a in a certain state sₜ is caused to approach the value of the best action in the next state sₜ₊₁ by the certain action a. As a result, an optimum CIP processing condition is decided.

When the processing of Step S11 is completed, the processing returns to Step S2, the setting value of the CIP processing condition is changed, and the action value function is similarly updated. Although the update part 912 updates the action value function, the present invention is not limited thereto, and an action value table may be updated.

As Q(s, a), values for all pairs (s, a) of states and actions may be stored in a table format. Alternatively, Q(s, a) may be expressed by an approximation function that approximates values for all pairs (s, a) of states and actions. This approximation function may be configured by a neural network having a multilayer structure. In this case, the neural network may in real time learn data obtained by actually moving the CIP device 100 and perform online learning to reflect the data in the next action. As a result, deep reinforcement learning is realized.

Specifically, in the reinforcement learning, the machine-learning system learns an action for maximizing a reward (score) set as an objective in a predetermined environment. On the other hand, in deep learning, by providing a plurality of intermediate layers of a neural network, it is possible to perform expression learning in which a machine-learning system extracts a feature from learning data by itself and constructs a prediction model. Therefore, in the deep reinforcement learning in which the deep learning is applied to the reinforcement learning in the present embodiment, the machine-learning system can extract a suitable feature from the CIP processing conditions (first parameter, second parameter, and third parameter) illustrated in FIG. 3 and the physical quantities of the workpiece W illustrated in FIGS. 5, 6, and 7. At this time, the machine-learning system may extract a new feature (e.g., a pressure/temperature ratio) including features that affect each other (interaction) in the operating conditions of FIG. 3, such as the processing pressure and the processing temperature, and change the feature. According to such a configuration, it is possible to more quickly and efficiently obtain a CIP processing condition enabling a high reward to be obtained. Furthermore, by executing such deep reinforcement learning as described above for the mass production process in advance, it is possible to realize the mass production process based on the desirable CIP processing condition.

Conventionally, in a CIP device, CIP processing conditions have been developed by changing CIP processing conditions so as to obtain a high-quality CIP processed article. In order to obtain good CIP processing conditions, it is required to find a relationship between evaluation of the workpiece W and the CIP processing conditions. However, since the number of types of CIP processing conditions is enormous as illustrated in FIG. 3, an extremely large number of physical models are required to define such a relationship, and it has been found that it is difficult to describe such a relationship by a physical model. Furthermore, in order to construct such a physical model, it is also required to artificially find which parameter affects the evaluation of which workpiece W, making this construction difficult.

According to the present embodiment, at least one parameter among the first to third parameters described above and at least one physical quantity among physical quantities related to densification and green compaction are observed as state variables. Then, a reward for the decision result of the CIP processing condition is calculated based on the observed state variable, the action value function for deciding the CIP processing condition from the state variable is updated based on the calculated reward, and the update is repeated to learn the CIP processing condition that maximizes the reward. As described above, in the present embodiment, the CIP processing condition is decided by machine-learning without using the above-described physical model. As a result, the present embodiment can efficiently and easily decide an appropriate CIP processing condition without depending on many years of experience by a skilled engineer.

In particular, when water or the like is caused to flow into the pressure vessel 1 as a pressure medium and the workpiece W is subjected to the CIP processing, the physical quantities (FIGS. 5, 6, and 7) of the workpiece W change while various processing conditions illustrated in FIG. 3 are correlated with each other. For example, when the arrangement, the shape, the dimensions, and the like of the workpiece W in the pressure vessel 1 are changed as the first parameter related to the workpiece W, there is a possibility that a difference occurs in the presence or absence of voids (FIG. 5, form information) as a result of a change in the action of a pressure on each workpiece W even at the same processing pressure (operating condition, third parameter). It is difficult to find such an influence of each physical quantity by many physical models. On the other hand, according to the present embodiment, the machine-learning system can efficiently decide a desirable CIP processing condition by learning a CIP processing condition involving a higher reward while updating the action value function. At this time, by applying deep reinforcement learning to the machine-learning system as described above, the system can extract a new physical quantity by itself and derive an appropriate CIP processing condition more quickly and efficiently.

As described above, in the present embodiment, the control device 800 transmits the state variable to the server via the network, and receives at least one machine-learned isostatic pressurization processing condition from the server. Furthermore, in a machine-learning method in which an isostatic pressurization processing condition is decided by a machine-learning device, the at least one isostatic pressurization processing condition is generated by the server calculating a reward for a decision result of the at least one isostatic pressurization processing condition based on the state variable, updating a function for deciding the at least one isostatic pressurization processing condition from the state variable based on the reward while changing the at least one isostatic pressurization processing condition, and deciding an isostatic pressurization processing condition that maximizes the reward by repeating updating of the function.

The present invention can adopt the following modified embodiment, for example.

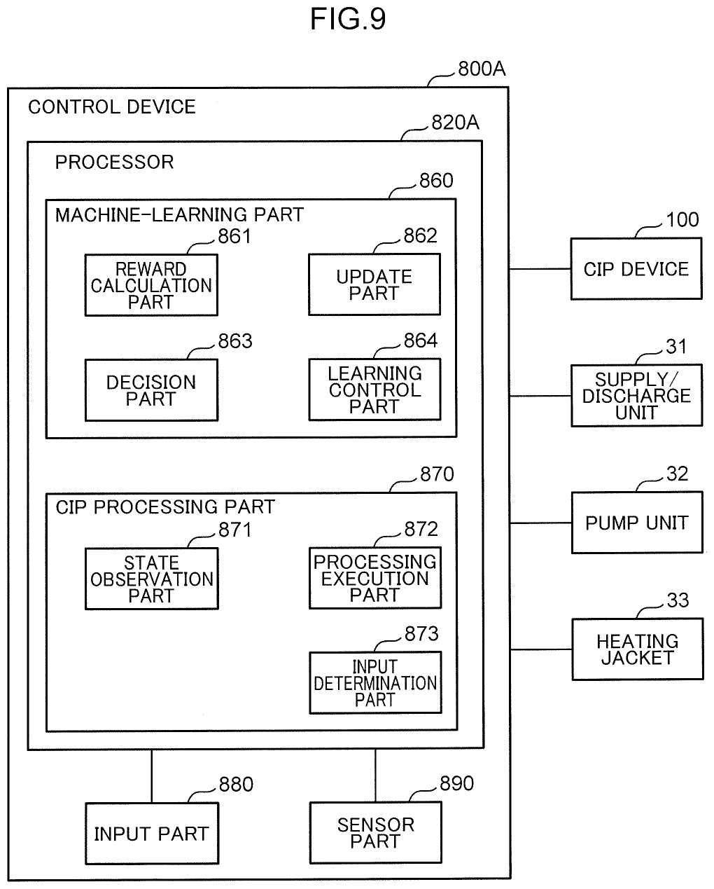

(1) FIG. 9 is an overall configuration diagram of a machine-learning system according to a modified embodiment of the present invention. The machine-learning system according to this modified embodiment is configured by a control device 800A alone. The control device 800A includes a processor 820A, an input part 880, and a sensor part 890. The processor 820A includes a machine-learning part 860 and a CIP processing part 870. The machine-learning part 860 includes a reward calculation part 861, an update part 862, a decision part 863, and a learning control part 864. The reward calculation part 861 to the learning control part 864 are the same as the reward calculation part 911 to the learning control part 914 illustrated in FIG. 2, respectively. The CIP processing part 870 includes a state observation part 871, a processing execution part 872, and an input determination part 873. The state observation part 871 to the input determination part 873 are the same as the state observation part 821, the processing execution part 822, and the input determination part 823 illustrated in FIG. 2, respectively. The input part 880 and the sensor part 890 are the same as the input part 840 and the sensor part 830 illustrated in FIG. 2, respectively. In the present modification, the state observation part 821 is an example of a state acquisition part that acquires state information. Note that the sensor part 890 may be provided inside the control device 800A or may be provided outside the control device 800A, and the installation location of the sensor part 890 is not particularly limited.

As described above, according to the machine-learning system according to the modified embodiment, an optimum CIP processing condition can be learned by the control device 800A alone.

(2) Although in the flow illustrated in FIG. 8, the state variable is observed after the completion of the CIP processing, this is an example, and a plurality of state variables may be observed during one CIP processing. For example, when the state variable is configured by only a parameter that can be instantaneously measured, a plurality of state variables can be observed during one CIP processing. As a result, the learning time can be shortened. In addition, when the CIP processing is started in Step S7 of FIG. 8, by performing the observation of the state variable and the evaluation of the physical quantity in parallel in the CIP processing, the CIP processing condition in processing can be changed so that a physical quantity of the workpiece W in the final stage of the CIP processing is brought closer to the reference value. Specifically, the machine-learning method executed by the machine-learning system according to the present invention includes not only a method of deciding an isostatic pressurization processing condition that maximizes a reward through a plurality of times of CIP processing but also a method of deciding an isostatic pressurization processing condition that maximizes a final reward during predetermined CIP processing.

(3) The communication method according to the present invention is executed by various processing at the time of communication of the control device 800 with the server 900 as illustrated in FIG. 2. In addition, the learning program according to the present invention is realized by a program that causes a computer to function as the server 900 illustrated in FIG. 2.

A machine-learning method according to one aspect of the present invention is a machine-learning method in which a machine-learning device decides an isostatic pressurization processing condition of an isostatic pressurization system that performs isostatic pressurization processing on a workpiece using a pressure medium. The isostatic pressurization system includes: an isostatic pressurization device that includes a pressure vessel that stores the workpiece, and is configured by a cold isostatic pressurization device or a warm isostatic pressurization device; a compressor configured to supply the pressure medium to the pressure vessel; a pressure adjustment mechanism capable of adjusting a pressure in the pressure vessel; and a control device that controls the isostatic pressurization device. The machine-learning method includes acquiring a state variable including at least one physical quantity related to the workpiece and at least one isostatic pressurization processing condition: calculating a reward for a decision result of the at least one isostatic pressurization processing condition based on the state variable; updating, based on the reward, a function for deciding the at least one isostatic pressurization processing condition from the state variable while changing the at least one isostatic pressurization processing condition; and deciding an isostatic pressurization processing condition that maximizes the reward by repeating updating of the function. The at least one isostatic pressurization processing condition is at least one of a first parameter related to the workpiece, a second parameter related to a pre-process of the isostatic pressurization processing, and a third parameter related to an operating condition of the isostatic pressurization device, and the at least one physical quantity is at least one of physical quantities related to densification and green compaction of the workpiece.

According to the present aspect, at least one of the first parameter related to a workpiece, the second parameter related to the pre-process of the isostatic pressurization processing, and the third parameter related to an operating condition of the isostatic pressurization device is acquired as the state variable. Furthermore, at least one physical quantity of the physical quantities related to densification and green compaction of the workpiece is acquired as the state variable.

Then, a reward for a decision result of the isostatic pressurization processing condition is calculated based on the acquired state variable, the function for deciding the isostatic pressurization processing condition from the state variable is updated based on the calculated reward, and the update is repeated to learn the isostatic pressurization processing condition for obtaining the most reward. Therefore, the isostatic pressurization processing conditions can be efficiently derived.

In the machine-learning method, the at least one isostatic pressurization processing condition may include the first parameter, and the first parameter may be at least one of a chemical component, a composition ratio, a processing amount, an arrangement, a shape, dimensions, a bulk density, and a true density of the workpiece.

According to the present aspect, for the first parameter, at least one of the chemical component, the composition ratio, the processing amount, the arrangement, the shape, the dimensions, the bulk density, and the true density of the workpiece is acquired as the state variable related to the workpiece to perform machine-learning. Therefore, it is possible to decide an appropriate isostatic pressurization processing condition in consideration of a state of the workpiece.

In the machine-learning method, the at least one isostatic pressurization processing condition may include the second parameter, and the second parameter may be at least one of a preheating temperature, a preheating time, and a degree of vacuum at a time of vacuum packaging.

According to the present aspect, since for the second parameter, at least one of the preheating temperature, the preheating time, and the degree of vacuum at the time of vacuum packaging is acquired as the state variable related to the pre-process to perform machine-learning, it is possible to decide an appropriate isostatic pressurization processing condition in consideration of a state of the pre-process of the isostatic pressurization processing.

In the machine-learning method, the at least one isostatic pressurization processing condition may include the third parameter, and the third parameter may be at least one of a processing pressure, a pressure increase rate, a pressure reduction rate, a pressure holding time, presence or absence of stepwise pressure increase, and presence or absence of stepwise pressure reduction in the isostatic pressurization processing.

According to the present aspect, for the third parameter, at least one of the processing pressure, the pressure increase rate, the pressure reduction rate, the pressure holding time, the presence or absence of stepwise pressure increase, and the presence or absence of stepwise pressure reduction in the isostatic pressurization processing is acquired as the state variable related to the operating condition to perform the machine-learning, so that an appropriate isostatic pressurization processing condition can be decided in consideration of the operating condition.

In the machine-learning method, the isostatic pressurization device may further include a temperature adjustment mechanism capable of adjusting a temperature of a pressure medium in the pressure vessel, and the control device may be capable of further controlling the temperature adjustment mechanism. In addition, the third parameter may be at least one of the processing pressure, the pressure increase rate, the pressure reduction rate, the pressure holding time, the presence or absence of stepwise pressure increase, the presence or absence of stepwise pressure reduction, a processing temperature, a temperature increase rate during processing, a temperature decrease rate during processing, and a temperature distribution in the isostatic pressurization processing.

According to the present aspect, the characteristics of the workpiece can be suitably changed by adjusting a temperature in the pressure vessel by the temperature adjustment mechanism. In addition, when for the third parameter, at least one of a processing temperature, a temperature increase rate during processing, a temperature decrease rate during processing, and a temperature distribution is acquired as the state variable related to the operating condition to perform machine-learning, an appropriate isostatic pressurization processing condition can be decided in consideration of the operating condition.

In the above machine-learning method, the function may be updated using deep reinforcement learning.

According to the present aspect, since a function is updated using the deep reinforcement learning, the function can be updated accurately and quickly. Therefore, the isostatic pressurization processing conditions can be more efficiently derived.

In the machine-learning method, in the calculation of the reward, in a case where the at least one physical quantity approaches a predetermined reference value corresponding to each physical quantity, the reward may be increased.

Since the reward increases as the physical quantity approaches the reference value, this configuration enables the physical quantity to quickly reach the reference value.

Note that in the present invention, each processing included in the above machine-learning method may be implemented in a machine-learning device, or may be implemented and distributed as a machine-learning program (learning program). The machine-learning device may be configured by a server or may be configured by an isostatic pressurization device.

A communication method according to another aspect of the present invention is a communication method of a control device of an isostatic pressurization device at a time of machine-learning an isostatic pressurization processing condition of the isostatic pressurization system, the isostatic pressurization system performing isostatic pressurization processing on a workpiece using a pressure medium. The isostatic pressurization system includes: an isostatic pressurization device that includes a pressure vessel that stores the workpiece, and is configured by a cold isostatic pressurization device or a warm isostatic pressurization device; a compressor configured to supply the pressure medium to the pressure vessel; a pressure adjustment mechanism capable of adjusting a pressure in the pressure vessel; and the control device. The control device observes a state variable including at least one physical quantity related to the workpiece and at least one isostatic pressurization processing condition. The control device transmits the state variable to a server via a network and receives at least one machine-learned isostatic pressurization processing condition from the server. The at least one isostatic pressurization processing condition is generated by the server calculating a reward for a decision result of the at least one isostatic pressurization processing condition based on the state variable; updating, based on the reward, a function for deciding the at least one isostatic pressurization processing condition from the state variable while changing the at least one isostatic pressurization processing condition; and deciding an isostatic pressurization processing condition that maximizes the reward by repeating updating of the function. The at least one isostatic pressurization processing condition is at least one of a first parameter related to the workpiece, a second parameter related to a pre-process of the isostatic pressurization processing, and a third parameter related to an operating condition of the isostatic pressurization device, and the at least one physical quantity is at least one of physical quantities related to densification and green compaction of the workpiece.

According to the present aspect, information necessary for machine-learning of the isostatic pressurization processing condition is provided. Such a communication method can be implemented also in an isostatic pressurization device.

A control device according to a further aspect of the present invention is a control device of an isostatic pressurization system that performs isostatic pressurization processing on a workpiece using a pressure medium. The isostatic pressurization system includes: an isostatic pressurization device that includes a pressure vessel that stores the workpiece, and is configured by a cold isostatic pressurization device or a warm isostatic pressurization device; a compressor configured to supply the pressure medium to the pressure vessel; a pressure adjustment mechanism capable of adjusting a pressure in the pressure vessel; a state observation part that observes a state variable including at least one physical quantity related to the workpiece and at least one isostatic pressurization processing condition; and a communication part that transmits the state variable to a server via a network and receives at least one machine-learned isostatic pressurization processing condition from the server. The at least one isostatic pressurization processing condition is generated by the server calculating a reward for a decision result of the at least one isostatic pressurization processing condition based on the state variable; updating, based on the reward, a function for deciding the at least one isostatic pressurization processing condition from the state variable while changing the at least one isostatic pressurization processing condition; and deciding an isostatic pressurization processing condition that maximizes the reward by repeating updating of the function. The at least one isostatic pressurization processing condition is at least one of a first parameter related to the workpiece, a second parameter related to a pre-process of the isostatic pressurization processing, and a third parameter related to an operating condition of the isostatic pressurization device, and the at least one physical quantity is at least one of physical quantities related to densification and green compaction of the workpiece.

According to the present invention, it is possible to efficiently derive an appropriate isostatic pressurization processing condition for a workpiece.

1. A machine-learning method in which a machine-learning device decides an isostatic pressurization processing condition of an isostatic pressurization system that performs isostatic pressurization processing on a workpiece using a pressure medium, wherein
the isostatic pressurization system includes:
an isostatic pressurization device that includes a pressure vessel that stores the workpiece, and is configured by a cold isostatic pressurization device or a warm isostatic pressurization device;
a compressor configured to supply the pressure medium to the pressure vessel;
a pressure adjustment mechanism capable of adjusting a pressure in the pressure vessel; and
a control device that controls the isostatic pressurization device,
the machine-learning method comprising:
acquiring a state variable including at least one physical quantity related to the workpiece and at least one isostatic pressurization processing condition;
calculating a reward for a decision result of the at least one isostatic pressurization processing condition based on the state variable;
updating, based on the reward, a function for deciding the at least one isostatic pressurization processing condition from the state variable while changing the at least one isostatic pressurization processing condition; and
deciding an isostatic pressurization processing condition that maximizes the reward by repeating updating of the function,
the at least one isostatic pressurization processing condition being at least one of a first parameter related to the workpiece, a second parameter related to a pre-process of the isostatic pressurization processing, and a third parameter related to an operating condition of the isostatic pressurization device, and
the at least one physical quantity being at least one of physical quantities related to densification and green compaction of the workpiece.

2. The machine-learning method according to claim 1, wherein
the at least one isostatic pressurization processing condition includes the first parameter, and
the first parameter is at least one of a chemical component, a composition ratio, a processing amount, an arrangement, a shape, dimensions, a bulk density, and a true density of the workpiece.

3. The machine-learning method according to claim 1, wherein
the at least one isostatic pressurization processing condition includes the second parameter, and
the second parameter is at least one of a preheating temperature, a preheating time, and a degree of vacuum at a time of vacuum packaging.

4. The machine-learning method according to claim 1, wherein
the at least one isostatic pressurization processing condition includes the third parameter, and
the third parameter is at least one of a processing pressure, a pressure increase rate, a pressure reduction rate, a pressure holding time, presence or absence of stepwise pressure increase, and presence or absence of stepwise pressure reduction in the isostatic pressurization processing.

5. The machine-learning method according to claim 1, wherein
the isostatic pressurization device further includes a temperature adjustment mechanism capable of adjusting a temperature of a pressure medium in the pressure vessel, and
the control device is capable of further controlling the temperature adjustment mechanism.

6. The machine-learning method according to claim 1, wherein
the isostatic pressurization device further includes a temperature adjustment mechanism capable of adjusting a temperature of a pressure medium in the pressure vessel,
the control device is capable of further controlling the temperature adjustment mechanism,
the third parameter is at least one of a processing pressure, a pressure increase rate, a pressure reduction rate, a pressure holding time, presence or absence of stepwise pressure increase, presence or absence of stepwise pressure reduction, a processing temperature, a temperature increase rate during processing, a temperature decrease rate during processing, and a temperature distribution in the isostatic pressurization processing.

7. The machine-learning method according to claim 1, wherein the function is updated using deep reinforcement learning.

8. The machine-learning method according to claim 1, wherein in the calculation of the reward, in a case where the at least one physical quantity approaches a predetermined reference value corresponding to each physical quantity, the reward is increased.

9. A machine-learning device that decides an isostatic pressurization processing condition of an isostatic pressurization system that performs isostatic pressurization processing on a workpiece using a pressure medium, wherein
the isostatic pressurization system includes:
an isostatic pressurization device that includes a pressure vessel that stores the workpiece, and is configured by a cold isostatic pressurization device or a warm isostatic pressurization device;
a compressor configured to supply the pressure medium to the pressure vessel;
a pressure adjustment mechanism capable of adjusting a pressure in the pressure vessel; and
a control device that controls the isostatic pressurization device,
the machine-learning device comprising:
a state acquisition part that acquires a state variable including at least one physical quantity related to the workpiece and at least one isostatic pressurization processing condition;
a reward calculation part that calculates a reward for a decision result of the at least one isostatic pressurization processing condition based on the state variable;
an update part that updates, based on the reward, a function for deciding the at least one isostatic pressurization processing condition from the state variable while changing the at least one isostatic pressurization processing condition; and
a decision part that decides an isostatic pressurization processing condition that maximizes the reward by repeating updating of the function,
the at least one isostatic pressurization processing condition being at least one of a first parameter related to the workpiece, a second parameter related to a pre-process of the isostatic pressurization processing, and a third parameter related to an operating condition of the isostatic pressurization device, and
the at least one physical quantity being at least one of physical quantities related to densification and green compaction of the workpiece.

10. A learning program of a machine-learning device that decides an isostatic pressurization processing condition of an isostatic pressurization system that performs isostatic pressurization processing on a workpiece using a pressure medium, wherein
the isostatic pressurization system includes:
an isostatic pressurization device that includes a pressure vessel that stores the workpiece, and is configured by a cold isostatic pressurization device or a warm isostatic pressurization device;
a compressor configured to supply the pressure medium to the pressure vessel;
a pressure adjustment mechanism capable of adjusting a pressure in the pressure vessel; and
a control device that controls the isostatic pressurization device,
the learning program causing a computer to function as:
a state acquisition part that acquires a state variable including at least one physical quantity related to the workpiece and at least one isostatic pressurization processing condition;
a reward calculation part that calculates a reward for a decision result of the at least one isostatic pressurization processing condition based on the state variable;
an update part that updates, based on the reward, a function for deciding the at least one isostatic pressurization processing condition from the state variable while changing the at least one isostatic pressurization processing condition; and
a decision part that decides an isostatic pressurization processing condition that maximizes the reward by repeating updating of the function,
the at least one isostatic pressurization processing condition being at least one of a first parameter related to the workpiece, a second parameter related to a pre-process of the isostatic pressurization processing, and a third parameter related to an operating condition of the isostatic pressurization device, and
the at least one physical quantity being at least one of physical quantities related to densification and green compaction of the workpiece.

11. A communication method of a control device of an isostatic pressurization system at a time of machine-learning an isostatic pressurization processing condition of the isostatic pressurization system, the isostatic pressurization system performing isostatic pressurization processing on a workpiece using a pressure medium, wherein
the isostatic pressurization system includes:
an isostatic pressurization device that includes a pressure vessel that stores the workpiece, and is configured by a cold isostatic pressurization device or a warm isostatic pressurization device;
a compressor configured to supply the pressure medium to the pressure vessel;
a pressure adjustment mechanism capable of adjusting a pressure in the pressure vessel; and
the control device,
the control device observing a state variable including at least one physical quantity related to the workpiece and at least one isostatic pressurization processing condition, and
the control device transmitting the state variable to a server via a network and receiving at least one machine-learned isostatic pressurization processing condition from the server, and
the at least one isostatic pressurization processing condition is generated by the server calculating a reward for a decision result of the at least one isostatic pressurization processing condition based on the state variable; updating, based on the reward, a function for deciding the at least one isostatic pressurization processing condition from the state variable while changing the at least one isostatic pressurization processing condition; and deciding an isostatic pressurization processing condition that maximizes the reward by repeating updating of the function,
the at least one isostatic pressurization processing condition is at least one of a first parameter related to the workpiece, a second parameter related to a pre-process of the isostatic pressurization processing, and a third parameter related to an operating condition of the isostatic pressurization device, and
the at least one physical quantity is at least one of physical quantities related to densification and green compaction of the workpiece.

12. A control device of an isostatic pressurization system that performs isostatic pressurization processing on a workpiece using a pressure medium, wherein
the isostatic pressurization system includes:
an isostatic pressurization device that includes a pressure vessel that stores the workpiece, and is configured by a cold isostatic pressurization device or a warm isostatic pressurization device;
a compressor configured to supply the pressure medium to the pressure vessel;
a pressure adjustment mechanism capable of adjusting a pressure in the pressure vessel;
a state observation part that observes a state variable including at least one physical quantity related to the workpiece and at least one isostatic pressurization processing condition; and
a communication part that transmits the state variable to a server via a network and receives at least one machine-learned isostatic pressurization processing condition from the server, and
the at least one isostatic pressurization processing condition is generated by the server calculating a reward for a decision result of the at least one isostatic pressurization processing condition based on the state variable; updating, based on the reward, a function for deciding the at least one isostatic pressurization processing condition from the state variable while changing the at least one isostatic pressurization processing condition; and deciding an isostatic pressurization processing condition that maximizes the reward by repeating updating of the function,
the at least one isostatic pressurization processing condition is at least one of a first parameter related to the workpiece, a second parameter related to a pre-process of the isostatic pressurization processing, and a third parameter related to an operating condition of the isostatic pressurization device, and
the at least one physical quantity is at least one of physical quantities related to densification and green compaction of the workpiece.
